(19) United States
(12) Patent Application Publication
(10) Pub. No.: US 2024/0221709 A1
(43) Pub. Date: Jul. 4, 2024

(54) ELECTRONIC PIANO PEDAL WITH TACTILE RESPONSE

(71) Applicant: Steinway Musical Instruments, Inc., New York, NY (US)

(72) Inventor: Benjamin Kelley Smith, Astoria, NY (US)

(21) Appl. No.: 18/091,296

(22) Filed: Dec. 29, 2022

(51) Int. Cl. G10H 1/34; G10H 1/00

(52) U.S. Cl. CPC G10H 1/348; G10H 1/0008; G10H 2220/275; G10H 2220/311

(57) ABSTRACT

A piano pedal system includes a pedal pivotable, over a full range of movement, between a first position and a second position; a sensor configured to output an electrical signal indicative of a position of the pedal; and a biasing member coupled to the pedal, the biasing member configured to apply a biasing force on the pedal in response to displacement of the pedal from the first position. The biasing force is substantially linear over the full range of movement.

### FIELD OF THE DISCLOSURE

The present disclosure relates to electronic piano pedals.

### BACKGROUND

Acoustic pianos, such as grand pianos, typically include three foot-operated pedals: a soft pedal (sometimes referred to as an una corda), a sostenuto pedal, and a sustain pedal (sometimes referred to as a damper pedal). These pedals alter the sound produced by the piano, for example, by moving dampers of the piano. The soft pedal modifies the tone quality and strength of notes. The sostenuto pedal selectively sustains note(s) from keys that are pressed at the time of the sostenuto pedal being depressed. The sustain pedal causes all notes to be sustained as long as the sustain pedal is depressed, producing a “sympathetic resonance” effect. Other pedal type(s) can instead or additionally be included, such as muffling pedals.

Digital pianos emulate the sound of acoustic pianos by digitally synthesizing notes. Some digital pianos include, or can be connected to, electronic pedals that emulate the effects of corresponding acoustic piano pedals.

### SUMMARY

Some aspects of this disclosure describe a piano pedal system. The piano pedal system includes: a pedal pivotable, over a full range of movement, between a first position and a second position; a sensor configured to output an electrical signal indicative of a position of the pedal; and a biasing member coupled to the pedal. The biasing member is configured to apply a biasing force on the pedal in response to displacement of the pedal from the first position. The biasing force is substantially linear over the full range of movement.

This and other described piano pedal systems can have one or more of at least the following characteristics.

In some implementations, the biasing member includes a spring. The spring is stretched or compressed from a first length to a second length as the pedal pivots from the first position to the second position. The second length differs from the first length by less than 25% the first length.

In some implementations, the pedal includes a proximal end arranged to be manipulated by a user, and a distal end. The pedal is pivotable about a fulcrum, the fulcrum arranged less than six inches from the proximal end of the pedal.

In some implementations, the fulcrum is arranged between three inches and five inches from the proximal end of the pedal.

In some implementations, the pedal includes a proximal end arranged to be manipulated by a user, and a distal end. The pedal is pivotable about a fulcrum, the fulcrum arranged between 35% and 65% of a length of the pedal from the proximal end of the pedal.

In some implementations, the pedal includes a proximal end arranged to be manipulated by a user, and a distal end. The pedal is pivotable about a fulcrum. The sensor is configured to detect the position of the pedal between the fulcrum and the distal end of the pedal.

In some implementations, the sensor is configured to detect the position of the pedal at the distal end of the pedal.

In some implementations, the biasing member includes a spring, the spring providing at least 90% of the biasing force on the pedal.

In some implementations, an angular displacement of the pedal between the first position and the second position is at least 10°.

In some implementations, the biasing force when the pedal is in the second position is no more than 110% greater than the biasing force when the pedal is halfway between the second position and the first position.

In some implementations, the biasing force when the pedal is halfway between the first position and the second position is between 1 kg and 5 kg.

In some implementations, the pedal has a weight less than 200 grams.

In some implementations, the pedal is at least six inches long.

In some implementations, the sensor includes a contactless inductive sensor or a contactless Hall sensor.

In some implementations, the piano pedal system includes a second pedal and a third pedal.

In some implementations, the piano pedal system includes a base on which the pedal is pivotably mounted. A first end of the biasing member bears against the base, and a second end of the biasing member applies the biasing force to the pedal.

In some implementations, the biasing member extends along an axis along which a lever arm of the pedal extends.

In some implementations, the pedal includes a proximal end arranged to be manipulated by a user, and a distal end. The pedal is pivotable about a fulcrum. The biasing member is arranged entirely between the fulcrum and the distal end.

In some implementations, the biasing member is arranged laterally adjacent to the pedal.

In some implementations, a digital piano system includes a digital piano; and the piano pedal system described above. The digital piano is configured to receive a first signal including the electrical signal or a variation thereof, the first signal based on an output of the sensor, and output an audio signal based on the position of the pedal.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a top view of an example of a piano pedal system.

FIG. 2 is a side view of an example of a piano pedal system.

FIG. 3 is a front view of an example of a piano pedal system.

FIG. 4 is a rear view of an example of a piano pedal system.

FIG. 5 is a diagram illustrating an example of a digital piano system.

### DETAILED DESCRIPTION

This disclosure relates to electronic piano pedals, e.g., for use with digital pianos and keyboards. Some digital pianos seek to emulate the “feel” of acoustic pianos, e.g., such that the force profile of a key of a digital piano matches the force profile of a key of an acoustic piano. This allows users who practice on digital pianos to experience the same feel they would get on an acoustic piano, which may be larger, more expensive, or otherwise inaccessible for practice.

Similar design principles can be applied to piano pedals: for an enhanced user experience, the motion, forces, and tactile response associated with pressing an electronic piano pedal (referred to collectively as “feel”) should be similar to the motion, forces, and tactile response associated with pressing an acoustic piano pedal. However, acoustic piano pedals are mechanically attached to other components of the acoustic piano (e.g., directly attached to trap work, such as springs and/or pedal rods, which in turn are attached to internal components of the piano housing, such as the damper), imparting to acoustic piano pedals a distinctive feel. Electronic piano pedals, which are typically electrically and/or communicably-connected to a corresponding digital piano, may lack these mechanical connections to these mechanisms typically found in an acoustic piano and, therefore, have different feels. Accordingly, implementations according to this disclosure includes various features that allow electronic piano pedals to better emulate the feel of acoustic piano pedals, e.g., pedals of grand pianos. For example, some implementations according to this disclosure provide an electronic pedal having a substantially linear biasing force, accurately mimicking the feel of acoustic piano pedals.

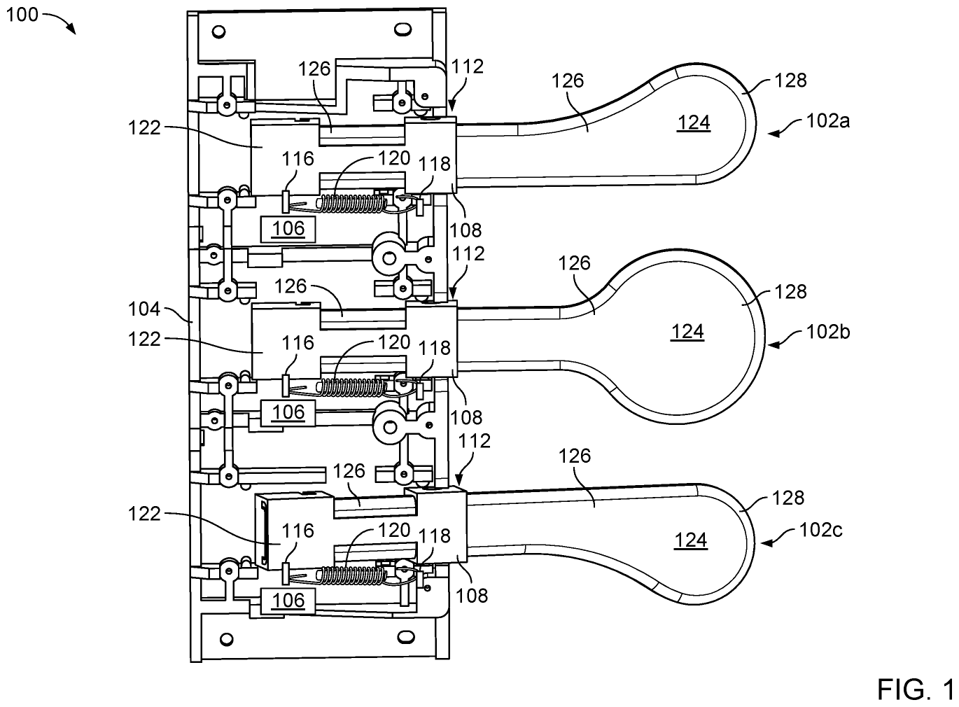

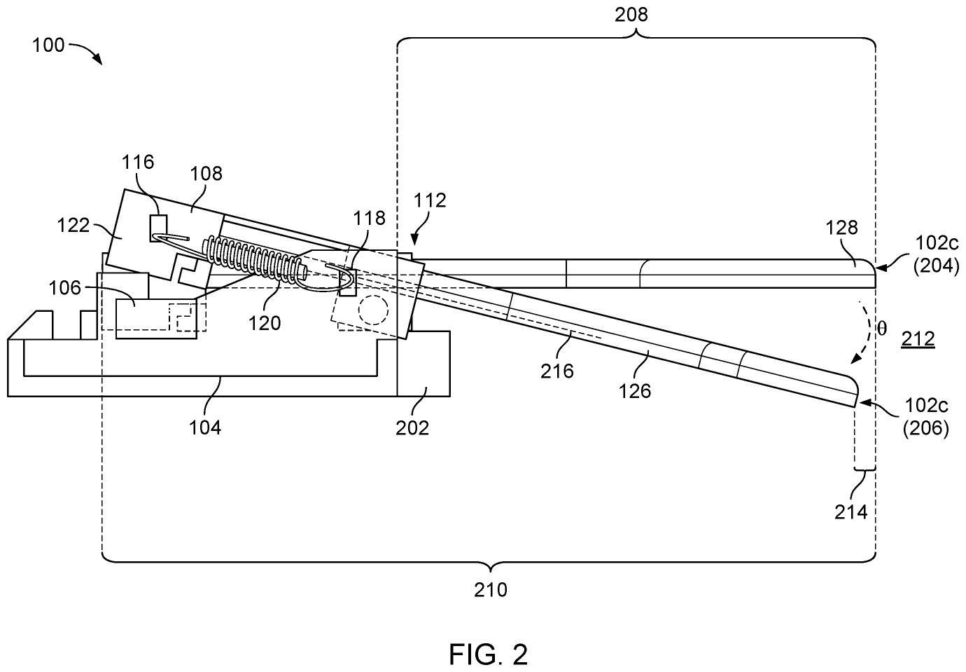

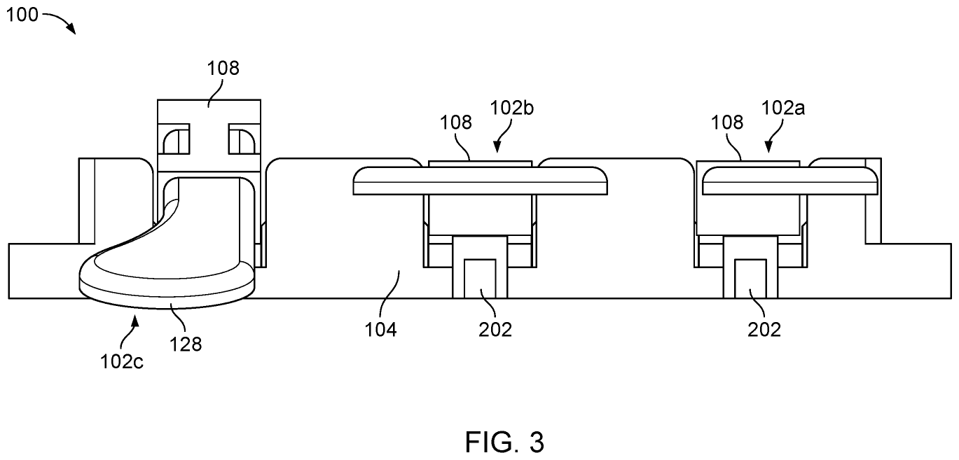

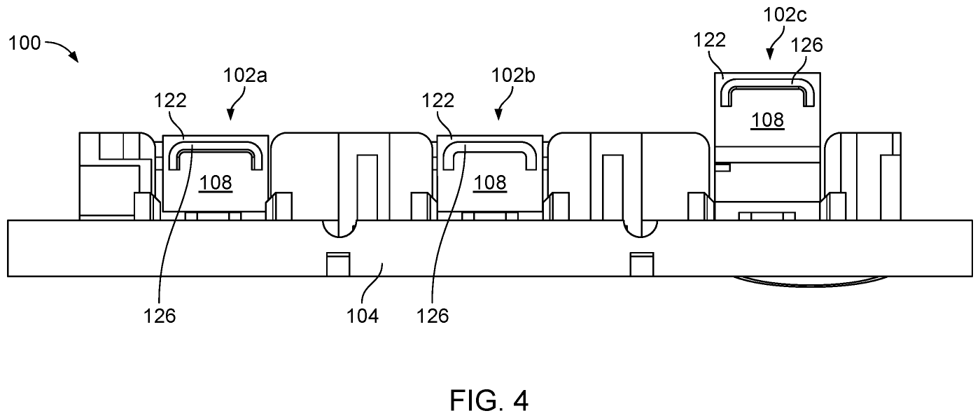

FIGS. 1-4 illustrate an example of a piano pedal system 100 according to some implementations of this disclosure. The piano pedal system 100 includes a base 104 on which are mounted three user-operable pedals 102a, 102b, 102c. FIG. 1 is a top view; FIG. 2 is a side view; FIG. 3 is a front view; and FIG. 4 is a rear view. As described in further detail below in reference to FIG. 2, the pedals 102 are illustrated with pedal 102c in a depressed position and pedals 102a, 102b in resting positions.

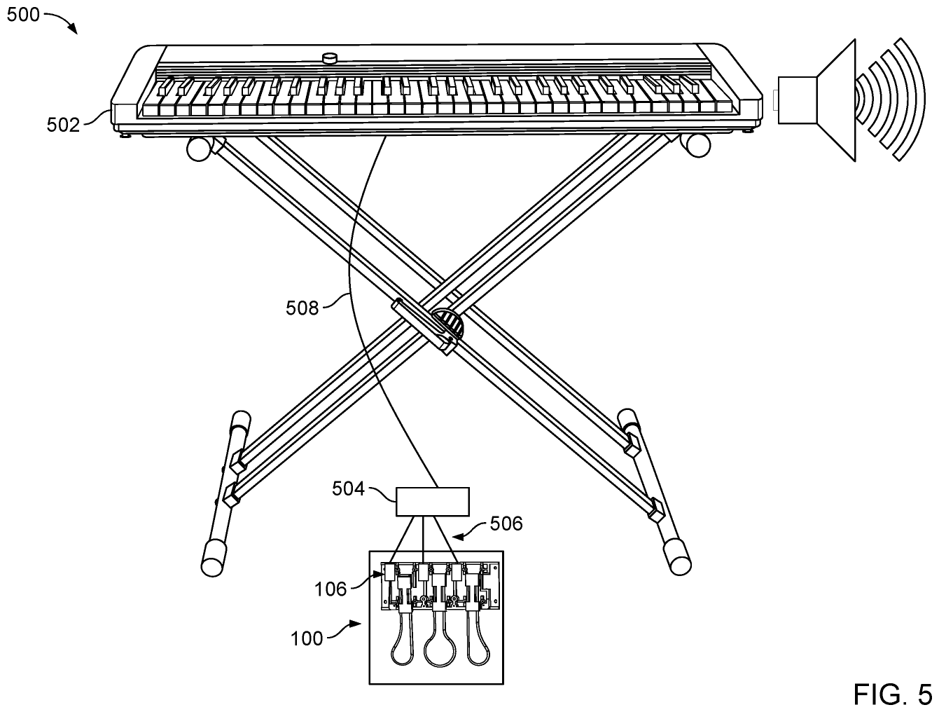

Each pedal 102 can have a corresponding function, which may be a predetermined function and/or a function configurable using a digital piano to which the piano pedal system 100 is connected, e.g., as described in reference to FIG. 5. For example, in some implementations, the three pedals 102c, 102b, 102a are a soft pedal, a sostenuto pedal, and a sustain pedal, respectively. In some implementations, the piano pedal system includes another number of piano pedals, e.g., one piano pedal, two piano pedals, or more than three piano pedals.

Each pedal 102 includes an elongate rigid member having a proximal end 128 and a distal end 122. The distal end 122 is in/on the base 104, while the proximal end 128 is outside the base 104 so that users can interact with the proximal end 128. The proximal end 128 is configured to be pressed down, e.g., by the foot of a user. For example, as shown in FIG. 1, a bulbous portion 124 of each pedal 102, on which the user's foot can be placed comfortably to depress the pedal 102, is disposed at each proximal end 128.

The pedals 102 can be integrally formed (e.g., a single piece of plastic, wood, metal, or another material) or can include multiple attached pieces. In the piano pedal system 100, each pedal 102 includes a housing 108 and a stem 126 partially embedded in the housing 108, such that the housing 108 and stem 126 pivot together as a unit. In some implementations, as in the piano pedal system 100, the housing 108 is disposed in/on the base 104, and the stem 126 extends from the base 104 to the proximal end 128 to be pressed by users. In some implementations, the housing 108 includes one or more openings through which the stem 126 is exposed. For example, as shown in FIGS. 1-2, lateral sides of the stem 126 are exposed through holes in the housing 108, and, as shown in FIG. 4, a rear side of the stem 126 is exposed through another hole in the housing 108.

For clarity, the base 104 is illustrated as open-faced, with the pedals 102 on top of the base 104. In some implementations, the base partially encloses the pedals 102. For example, the portion of the pedals 102 having the housing 108 can be enclosed within the base, such that only the stem 126 is visible outside the base. Components beside the stem 126 (such as biasing member 120 and sensors 106, described in further detail below) can also be enclosed within the base, such that the user primarily sees and interacts with the stem 126, which can be aesthetically pleasing, e.g., formed of polished metal.

As shown in FIG. 2, each pedal 102 is pivotable between a first position 204 and a second position 206; a rotation angle 212 (θ) is defined between the first position 204 and the second position 206. In some implementation, the first position 204 and the second position 206 define a full range of movement for the pedal 102, with the pedal 102 prevented from being rotated outside that range. In some implementations, one or more features of the piano pedal system 100 are arranged to prevent rotation of the pedal 102 outside that range. For example, the base 104 can include a first stop 202 arranged to contact the pedal 102 when the pedal 102 is in the second position 206, thereby preventing further rotation of the pedal 102. As another example, the base 104 can include a second stop (not shown) arranged to contact the pedal 102 when the pedal 102 is in the first position 204, thereby preventing rotation of the pedal 102 past the first position 204. In some implementations, the piano pedal system 100 is configured so that, when the piano pedal system 100 is placed on a floor surface, the floor surface defines the second position 206 by contacting the pedal 102 when the pedal 102 reaches the second position 206.

In some implementations, the first position 204 is a “resting” position to which the pedal 102 returns in the absence of force/pressure by the user (e.g., based on action by the biasing member 120), and the second position 206 is a “depressed” position to which the pedal 102 in response to downward pressure by the user. In some implementations, the pedal 102 is horizontal when in the first position 204.

To rotate between the first position 204 and the second position 206, the pedal 102 is pivotable about a fulcrum 112. The fulcrum 112 can take a variety of forms in different implementations. In some implementations, the pedal 102 rests on a support surface, such as the base 104, and pivots about a point of contact with the surface; the point of contact is the fulcrum 112. In some implementations, the pedal 102 is attached to a rotatable axle, and the axis of rotation of the axle defines the fulcrum 112. For example, the pedal 102 can be attached to an axle that rotates with respect to the base 104 (e.g., the axle can rotate within pockets of the base 104). In some implementations, the axle extends through the pedal 102. In some implementations, the axle is formed by extensions of the housing 108, e.g., two extensions on either side of the housing 108, without extending entirely through the pedal 102.

Dimensions of the pedal 102 and/or aspects of the pedal's rotation can be configured to provide a user experience similar to that provided by acoustic piano pedals. In some implementations, the position of the fulcrum 112 with respect to the pedal 102 can provide a more similar feel. For example, in some implementations, the fulcrum 112 is positioned relatively close to the proximal end 128, compared to some electronic piano pedals in which the fulcrum is positioned near the distal end 122. For example, in some implementations, a distance 208 between the fulcrum 112 and the proximal end 128 is less than six inches, e.g., between three inches and five inches from the proximal end 128. In some implementations, the distance 208 between the fulcrum 112 and the proximal end 128 is less than 75% of a length 210 of the pedal 102, such as between 35% and 65% of the length 210. In some implementations, the length 210 of the pedal 102 is at least six inches, at least seven inches, or at least eight inches, which can provide a desired feel for the user in combination with one or more other features of the piano pedal system 100 as described herein.

Arranging the fulcrum 112 relatively close to the proximal end can provide a relatively large rotation angle 212 between the first position 204 and the second position 206, e.g., for a given spatial displacement between the first position 204 and the second position 206. In some implementations, the rotation angle 212 is at least 10°, at least 15°, at least 20°, or at least 25°, for example, and up to 30°, 35°, 40°, or 45°. Users can sense even small differences in the rotation angle 212, and larger rotation angles 212, in some cases, might provide a feel more similar to that provided by acoustic piano pedals. In some cases, when the rotation angle 212 is larger between the first position 204 and the second position 206, the proximal end 128 is displaced further back (in the distal direction) in the second position 206 compared to the first position 204, replicating the experience of an acoustic piano pedal better than some electronic piano pedals that have a different rotation angle 212. For example, in some implementations, the proximal end 128 is displaced back by a distance 214 that is at least 2% or at least 3% the length 210 of the pedal 102, and/or that is at least 0.1 inches, at least 0.15 inches, or at least 0.2 inches. By contrast, when the fulcrum 112 is arranged too close to the distal end 122, the user experiences an almost entirely vertical displacement of the proximal end 128 when pressing the pedal 102 from the first position 204 to the second position 206, with a small rotation angle that may feel unnatural or un-ergonomic.

The piano pedal system 100 further includes a biasing member 120 coupled to the pedal 102. The biasing member 120 is configured to apply a biasing force on the pedal 102 in response to displacement of the pedal 102 from the first position 204. For example, the biasing force can be a force in a direction that returns the pedal 102 back to the first position 204, e.g., a counterclockwise torque from the perspective of FIG. 2, in response to the pedal 102 pivoting in the clockwise direction away from the first position 204 towards the second position 206. The biasing force may be sufficient to return the pedal 102 to the first position 204 in the absence of user pressure on the pedal 102. In some implementations, the biasing force is zero when the pedal 102 is in the first position 204. In some implementations, the biasing force is non-zero when the pedal 102 is in the first position 204, and another force (e.g., the presence of a retaining member or other component that contacts the pedal 102) maintains the pedal in the first position 204 in the absence of the user pushing on the pedal 102. A non-zero biasing force when the pedal is in the first position 204 can prevent inadvertent actuation of the pedal 102, allowing a user to rest their feet on the pedal 102 without causing the pedal 102 to be rotated. For example, in some implementations, the non-zero biasing force when the pedal is in the first position 204 is between 0.5 kg and 2 kg. In some implementations, the biasing member 120 is configured such that the biasing force is larger for larger displacements of the pedal 102 from the first position 204.

In some implementations, the biasing member 120 is configured to apply a substantially linear biasing force over the full range of movement between the first position 204 and the second position 206. A linear biasing force is a force that increases linearly with increasing displacement of the pedal 102 from the first position 204. For example, a linear biasing force can be expressed as F=−kφ, where k is a constant and q is the angular displacement of the pedal 102 from the first position 204. A substantially linear biasing force can be a biasing force for which k varies by less than 10% or by less than 5% over the full range of movement between the first position 204 and the second position 206. For example, the biasing force when the pedal 102 is in the second position 206 may be no more than 110% greater than the biasing force when the pedal 102 is halfway between the second position 206 and the first position 204. In some implementations, a substantially linear biasing force can provide an improved user experience compared to electronic piano pedals having pedal biasing configurations in which, for example, the biasing force is significantly non-linear.

The magnitude of the biasing force can depend, among other possible factors, on the weight of the pedal 102 and the type of biasing member 120. In some implementations, the biasing force when the pedal 102 is halfway between the first position 204 and the second position 206 is between 9 N and 50 N. In some implementations, the pedal has a weight less than 200 g, e.g., between 100 g and 200 g.

The biasing member 120 can take various forms in different implementations. In some implementations, the biasing member 120 includes a spring, such as a helical (coil) spring, a conical spring, or a torsion spring. The spring can be, for example, a compression helical spring or an extension helical spring. In some implementations, the biasing member 120 includes an elastic member, such as an extended portion of rubber or another springy material (e.g., a rubber band or a springy metal) that applies the biasing force in response to being compressed and/or stretched.

In some implementations, the biasing member 120 includes a spring, and the spring is configured to provide the substantially linear biasing force, e.g., to provide at least 90% of the biasing force, at least 95% of the biasing force, or all of the biasing force. For example, in some implementations, the spring is stretched or compressed from a first length (sometimes referred to as a “free length”) to a second length as the pedal 102 pivots from the first position 204 to the second position 206. To provide a substantially linear biasing force, the second length can represent a relatively small deviation from the first length. For example, the second length can differ from the first length by less than half the first length, e.g., such that the second length is less than 1.5× the first length (if the spring stretches from the first length to the second length) or such that the second length is greater than 0.5× the first length (if the spring compresses from the first length to the second length). In some implementations, the second length can differ from the first length by less than 25% the first length or by less than 10% the first length. For example, in some implementations, the spring is a first length between one and two inches long when the pedal 102 in the first position 204 and less than 10% different from the first length when the pedal 102 is in the second position 206. In some implementations, the difference between the first length and the second length is less than half the first length, less than 25% the first length, or less than 10% the first length. These spring parameters can help provide the substantially linear biasing force that promotes a feel similar to that of an acoustic piano, e.g., because a spring that is compressed or stretched by too-great a proportion of its length may have a non-linear force response. In addition, these spring parameters can result in less acoustically-noisy movement of the spring, compared to increased noise that may be generated when a spring that is stretched or compressed a greater proportion of its length.

The biasing member 120 can be coupled between the pedal 102 and a stationary element of the piano pedal system 100, such as the base 104. As shown in FIGS. 1-2, in the piano pedal system 100, the biasing member 120 is coupled between (i) a first fastening 116 on the housing 108 adjacent to the distal end 122 and (ii) a second fastening 118 on the base 104 adjacent to the fulcrum 112. For example, the fastenings 116, 118 can include clips, adhesive attachments, welded attachments, and/or another suitable type of fastening to fix the biasing member 120 between the pedal 102 and the stationary element such as the base 104. A first end of the biasing member, at the first fastening 116, can apply the biasing force to the pedal, and a second end of the biasing member, at the second fastening 118, can bear against the base 104. In this example, the biasing member 120 does not extend past the fulcrum 112 towards the proximal end 128, e.g., is arranged entirely between the fulcrum 112 and the distal end 122. The fastening 116 need not be made to the housing 108 but can be made to another portion of the pedal 102, such as the stem 126. In some implementations, when the base 104 partially encloses the pedal 102, the biasing member 120 is enclosed within the base 104.

In some implementations, a spatial arrangement of the biasing member 120 aids in providing a substantially linear biasing force. In the piano pedal system 100, as shown in FIG. 2, the biasing member 120 extends along an axis 216 along which the pedal 102 extends, e.g., the biasing member 120 extends longitudinally along the pedal 102. In some implementations, an angle between the extension direction of the biasing member 120 and the axis 216 along which the pedal 102 extends is less than 45° or less than 25° over the full range of motion of the pedal 102 between the first position 204 and the second position 206, where the example of FIG. 2 corresponds to an angle of 0°. Moreover, in some implementations, as in the piano pedal system 100, the biasing member 120 for each pedal 102 is arranged laterally adjacent to the pedal 102, e.g., next to the pedal 102. In some cases, one or more of these arrangements can allow a spring of the biasing member 120 to have sufficient length to provide a linear response. For example, a spring arranged under a pedal, that stretches or compresses in a direction approximately perpendicular to the pedal's axis of extension, may necessarily stretch or compress by a significant proportion of its free length, resulting in high levels of noise and/or non-linear force. However, other orientations of the biasing member 120 are also within the scope of this disclosure.

The piano pedal system 100 further includes a sensor 106 (illustrated schematically in FIGS. 1-2) configured to output an electrical signal indicative of a position of the pedal 102. For example, the electrical signal can indicate an angular position of the pedal 102 (e.g., including indicating positions between the first position 204 and the second position 206), and/or the electrical signal can indicate, in a binary manner, whether the pedal 102 is or is not in the second position 206, corresponding to the pedal 102 being pressed. The sensor 106 can detect the position of the pedal 102 at one or more positions along the pedal 102. In some implementations, as shown in FIGS. 1-2, the sensor 106 detects a position of the pedal 102 between the fulcrum 112 and the distal end 122, e.g., a position of the pedal 102 at or in proximity to the distal end 122. Detecting the position of the pedal 102 at or in proximity to the distal end 122 can increase a magnitude of displacement detected by the sensor 106, improving measurement accuracy/precision.

The sensor 106 can include one or more sensor types. In some implementations, the sensor 106 includes a potentiometer (e.g., a linear potentiometer), e.g., in which pivoting of the pedal 102 causes adjustment of the resistance of the potentiometer, such as by causing mechanical movement of a sliding or rotating component of the potentiometer; the adjusted resistance results in one or more adjusted currents and/or voltages that are indicative of the position of the pedal 102. In some implementations, the sensor 106 includes an inductive sensor. For example, the pedal 102 can include a conductive portion (e.g., a metal portion) or a magnetic portion that induces a current in the inductive sensor, the current indicative of the position of the pedal 102. In some implementations, the sensor 106 includes a Hall (Hall effect) sensor that detects a magnetic field associated with the pedal 102 (e.g., a metal or magnetic portion of the pedal 102) to determine the position of the pedal 102. In some implementations, the sensor 106 includes an optical sensor, e.g., a sensor that emits a laser onto a portion of the pedal 102 and detects reflections thereof to determine the position of the pedal 102. Inductive, Hall, and optical sensors can be contactless, aiding in providing a feel for the pedal 102 that is similar to the feel of an acoustic piano pedal. Contactless sensors can detect the position of the pedal 102 from various position, e.g., from the side, adjacent to the pedal 102 (as shown in FIGS. 1-2); from below, under the pedal 102; or from behind, past the distal end 122 of the pedal 102.

In some implementations, the sensor 106 includes circuitry, such as digital and/or analog circuitry, configured to process signal(s) in one or more ways to produce the output signal. For example, the circuitry can include one or more amplifiers, attenuators, filters, analog-to-digital converters (ADCs), and/or digital-to-analog converter (DACs). In some implementations, the sensor 106 includes digital circuitry, e.g., a microprocessor configured to perform one or more operations, such as operations that include outputting the electrical signal indicative of the position of the pedal.

In some implementations, one or more circuit boards (e.g., printed circuit boards (PCBs)) can be arranged under one or more pedals 102, e.g., mounted between the pedals 102 and the base 104. For example, the piano pedal system 100 can include a PCB (not shown) that extends over the base 104 under each of the pedals 102a, 102b, 102c, the PCB including position sensor circuitry to sense the respective positions of the pedals 102a, 102b, 102c.

The electrical signal output by the sensor can include an analog signal and/or a digital signal. In some implementations, the electrical signal is output in wireless form, e.g., over a wireless network such as a Bluetooth network or a Wi-Fi network.

In some implementations, the piano pedal system is used in combination with a digital piano. The position(s) of one or more pedals of the piano pedal system can determine characteristics of one or more sounds/audio signals output by the digital piano As shown in FIG. 18, a digital piano system 500 includes a digital piano 502 and the piano pedal system 100, including sensors 106 configured to output electrical signals indicative of the positions of the three pedals 102a, 102b, 102c. The sensors 106 are communicatively coupled to the digital piano 502, such that the digital piano 502 receives the electrical signals or variations thereof. For example, in some implementations, cables 506 couple each sensor 106 to a multiplexer circuit 504 (e.g., an analog or digital multiplexer) that combines the respective signals from each sensor 106 into a common signal that is output to the digital piano 502 over cable 508. In some implementations, the digital piano 502 receives the electrical signals or variations thereof wirelessly, e.g., over one or more wireless networks such as a Bluetooth network or a Wi-Fi network. The digital piano 502 can receive the electrical signals themselves or variations of the electrical signals, e.g., amplified, attenuated, filtered, and/or processed in one or more ways (e.g., using an ADC or a DAC). The signals received by the digital piano 502 are indicative of the positions of one or more pedals of the piano pedal system 100.

In some implementations, the digital piano 502 and the piano pedal system 100 are integrated together into a single device. In some implementations, the piano pedal system 100 is replaceable and connectable to the digital piano 502 as a standalone unit. For example, the piano pedal system 100 may be disconnected from the digital piano 502 and connected to another digital piano, e.g., of another model or the same model as the digital piano 502.

The digital piano 502 is configured to output an audio signal based on the position of at least one pedal of the piano pedal system 100, as indicated by the signal(s) received by the digital piano 502. For example, in some implementations, each pedal is associated with a sound modification, and the digital piano 502 outputs a modified audio signal based on the sound modification when the pedal is pressed (e.g., in the second position 206). For example, if pedal 102a is configured as a sustain pedal, the digital piano 502 can output audio signals of sustained digital notes produced while the pedal 102a is pressed. As another example of sound modification, if pedal 102c is configured as a soft pedal, the digital piano can output audio signals processed with digital effects to mimic the tone modifications of an acoustic piano's soft pedal. In some implementations, the digital piano 502 is configured to output an audio signal of a specific type of sound when one or more pedals are pressed, e.g., a sound of a particular type of instrument (e.g., with a note corresponding to a note played on the digital piano 502) can be played when a given pedal is pressed. In some implementations, the pedals can be configured to serve control functions for the audio signal, e.g., to toggle a sound or sound sequence (e.g., a background drum beat) on/off or to otherwise switch between function(s) of the digital piano.

In some implementations, the piano pedal system 100 and/or the digital piano 502 is configurable to adjust how the position of each pedal modifies the audio signal output by the digital piano 502. For example, the user can interact with a user interface of the digital piano 502 to adjust a function of each pedal.

The audio signal output based on the position of a pedal may, in some implementations, be output not merely on the binary basis of whether a pedal is pressed (e.g., whether the pedal is in the second position 206) but on a position of the pedal between the first position 204 and the second position 206. For example, in some implementations, a degree of modification of the audio output (e.g., a strength of an added audio effect associated with the pedal) increases continuously as the pedal is pressed further towards the second position 206 from the first position 204.

The audio signal output by the digital piano 502 can, for example, be output to a speaker, such that the speaker outputs a sound based on the position of one or more pedals. In some implementations, the digital piano 502 includes a speaker configured to output the sound in response to receiving the audio signal. The audio signal can be an analog signal and/or a digital signal. The digital piano 502 can include digital circuitry, such as a computing device, configured to receive first signal(s) that include electrical signals output from one or more pedal position sensors (or variations thereof) and generate audio signal(s) based on the signal(s), as described above.

Some features described may be implemented in digital and/or analog electronic circuitry or in computer hardware, firmware, software, or in combinations of them. Some features may be implemented in a computer program product tangibly embodied in an information carrier, e.g., in a machine-readable storage device, for execution by a programmable processor. Method steps may be performed by a programmable processor executing a program of instructions to perform functions of the described implementations by operating on input data and generating output, by discrete circuitry performing analog and/or digital circuit operations, or by a combination thereof.

Some described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A piano pedal system, comprising:
a pedal pivotable, over a full range of movement, between a first position and a second position;
a sensor configured to output an electrical signal indicative of a position of the pedal; and
a biasing member coupled to the pedal, the biasing member configured to apply a biasing force on the pedal in response to displacement of the pedal from the first position,
wherein the biasing force is substantially linear over the full range of movement.

2. The piano pedal system of claim 1, wherein the biasing member comprises a spring,
wherein the spring is stretched or compressed from a first length to a second length as the pedal pivots from the first position to the second position, and
wherein the second length differs from the first length by less than 25% the first length.

3. The piano pedal system of claim 1, wherein the pedal comprises
a proximal end arranged to be manipulated by a user, and
a distal end; and
wherein the pedal is pivotable about a fulcrum, the fulcrum arranged less than six inches from the proximal end of the pedal.

4. The piano pedal system of claim 3, wherein the fulcrum is arranged between three inches and five inches from the proximal end of the pedal.

5. The piano pedal system of claim 1, wherein the pedal comprises
a proximal end arranged to be manipulated by a user, and
a distal end; and
wherein the pedal is pivotable about a fulcrum, the fulcrum arranged between 35% and 65% of a length of the pedal from the proximal end of the pedal.

6. The piano pedal system of claim 1, wherein the pedal comprises
a proximal end arranged to be manipulated by a user, and
a distal end;
wherein the pedal is pivotable about a fulcrum; and
wherein the sensor is configured to detect the position of the pedal between the fulcrum and the distal end of the pedal.

7. The piano pedal system of claim 6, wherein the sensor is configured to detect the position of the pedal at the distal end of the pedal.

8. The piano pedal system of claim 1, wherein the biasing member comprises a spring, the spring providing at least 90% of the biasing force on the pedal.

9. The piano pedal system of claim 1, wherein an angular displacement of the pedal between the first position and the second position is greater than 10°.

10. The piano pedal system of claim 1, wherein the biasing force when the pedal is in the second position is no more than 110% greater than the biasing force when the pedal is halfway between the second position and the first position.

11. The piano pedal system of claim 1, wherein the biasing force when the pedal is halfway between the first position and the second position is between 1 kg and 5 kg.

12. The piano pedal system of claim 1, wherein the pedal has a weight less than 200 grams.

13. The piano pedal system of claim 1, wherein the pedal is at least six inches long.

14. The piano pedal system of claim 1, wherein the sensor comprises a contactless inductive sensor or a contactless Hall sensor.

15. The piano pedal system of claim 1, comprising a second pedal and a third pedal.

16. The piano pedal system of claim 1, comprising a base on which the pedal is pivotably mounted,
wherein a first end of the biasing member bears against the base, and
wherein a second end of the biasing member applies the biasing force to the pedal.

17. The piano pedal system of claim 1, wherein the biasing member extends along an axis along which a lever arm of the pedal extends.

18. The piano pedal system of claim 1, wherein the pedal comprises
a proximal end arranged to be manipulated by a user, and
a distal end;
wherein the pedal is pivotable about a fulcrum; and
wherein the biasing member is arranged entirely between the fulcrum and the distal end.

19. The piano pedal system of claim 1, wherein the biasing member is arranged laterally adjacent to the pedal.

20. A digital piano system, comprising:
a digital piano; and
the piano pedal system of claim 1,
wherein the digital piano is configured to:
receive a first signal comprising the electrical signal or a variation thereof, the first signal based on an output of the sensor, and
output an audio signal based on the position of the pedal.
